(19) United States
(12) Patent Application Publication
(10) Pub. No.: US 2005/0208962 A1
(43) Pub. Date: Sep. 22, 2005

(54) Mobile phone, multimedia chatting system and method thereof

(75) Inventor: Joo Min Kim, Seoul (KR)

Correspondence Address: JONATHAN Y. KANG, ESQ.;LEE, HONG, DEGERMAN, KANG & SCHMNADEKA, 14th Floor, 801 S. Figueroa Street, Los Angeles, CA, 90017, US

(73) Assignee: LG Electronics Inc.

(21) Appl. No.: 11/086,843

(22) Filed: Mar. 21, 2005

(30) Foreign Application Priority Data
Mar. 22, 2004 (KR) 19396/2004

(51) Int. Cl. H04L 12/66; H04B 1/38; H04M 1/00

(52) U.S. Cl. 455/550.1; 455/566

(57) ABSTRACT

A mobile phone multimedia chatting system and a method thereof is provided for transmitting text inputted from a user with selected image and selected audio. According to the mobile phone, the multimedia chatting system and the method thereof, not only videophone but also the multimedia chatting is provided to a user without modifying a related art of H.324 protocol. Also, the multimedia chanting service is provided to a mobile phone without a built-in camera or a built-in microphone.

### BACKGROUND OF THE INVENTION

1. Field of the Invention

The present invention relates to a mobile phone and a multimedia chatting system, and more particularly, to a multimedia chatting system in a mobile phone driven based on H.324 which is a protocol of videophone in the 3^{rd} generation partnership project (3GPP) and a method thereof.

2. Description of the Related Art

H.324 is a protocol for operating a telephone terminal for multimedia communication in very low bit-rate over the General Switched Telephone Network (GSTN).

A H.324 terminal provides real-time video, audio, or data, or any combination, between two multimedia telephone terminals over a GSTN voice band network connection. Communication may be either 1-way or 2way.

FIG. 1 is a diagram illustrating a H.324 multimedia videophone system in accordance with the related art. As shown, the H.324 multimedia videophone system includes terminal equipment, a GSTN modem, a GSTN network, a Multipoint Control Unit (MCU) 8.

A video input/output (I/O) unit includes a camera, a monitor, video processing to improve a compression rate and provides split-screen functions. Audio input/output (I/O) unit includes a microphone, a loudspeaker, an earphone and audio processing for processing voice.

A user data application unit 3 provides data applications such as electronic whiteboards, still image transfer, file exchange, database access, audiographics conferencing, remote device control and network protocols. Standardized data applications include T.120 for real-time audiographics conferencing, T.84 for simple point-point still image file transfer, T.434 simple point-point file transfer and H.224/H.281 for far-end camera control.

The control protocol H.223 4 provides end-to-end signaling to exchange messages between two terminals for properly controlling operations of the H.324 terminal. The messages are classified to “Request Message” for requesting a predetermined operation of a receiver with an instant response, ‘Response Message’ for responding to the ‘Request Message’, ‘Command Message’ for requesting a predetermined operation without requesting ‘Response Message’, and ‘Indication Message’ providing information without requesting either of a predetermined operation and the ‘Response Message’.

Multiplex protocol H.223 5 multiplexes transmitted video, audio, data and control streams into a signal bit stream, and demultiplexes a received bit stream into various multimedia streams. In addition, the multiplex protocol H.223 performs logical framing, sequence numbering, error detection, and error correction by means of retransmission, as appropriate to each media type.

A Modem V.34 6 converts the H.223 synchronous multiplexed bit stream into an analogue signal that can be transmitted over the GSTN, and converts the received analogue signal into a synchronous bit stream that is sent to the Multiplex/Demultiplex protocol unit. ITU-T Rec. V.250 is used to provide control/sensing of the modem/network interface. GSTN network interface 7 provides appropriate signaling, ringing functions and voltage levels in accordance with national standards.

However, since the H.324 terminal transmits a predetermined image and audio only, a user has difficulties to transmit other images and audio beside of the predetermined image and audio. Also, entire design of the protocol H.324 has to be changed if a user wants to change a service type of the H.324 to a target service type which is wanted by a user.

Specially, a use cannot transmit an image by using a H.234 mobile phone without a built-in camera. That is, a H.324 mobile phone only transmits an image photographed by the built-in camera in the H.324 mobile phone.

### SUMMARY OF THE INVENTION

Accordingly, the present invention is directed to a mobile phone, a multimedia chatting system and a method thereof that substantially obviates one or more problems due to limitations and disadvantages of the related art.

An object of the present invention is to provide a mobile phone providing a multimedia chatting without additional multimedia server in H.324 videophone protocol standardized in 3^{rd} Generation Partnership Project (3GPP) and a multimedia chatting system and a method thereof.

Another object of the present invention is to provide a multimedia chatting system for using multimedia chatting service by using a mobile phone without additional built-in camera equipped or a built-in microphone equipped, and a method thereof.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a mobile phone, including: an image data selector for selecting a type of an image to be transmitted: an audio data selector for selecting a type of audio to be transmitted; a user input text receiver for receiving a text from a user; a communication processing unit for transmitting the selected image by the image data selector, the selected audio by the audio data selector and the inputted text by the user input receiver; a menu button for changing image data and/or audio data; and a receiver for processing data received from an external device by the communication processing unit.

In another aspect of the present invention, there is provided a multimedia chatting system, including: an image data selector for selecting an image to be transmitted; an audio data selector for selecting audio to be transmitted; a user input text receiver for receiving a text; and a communication processing unit for transmitting the selected image by the image data selector, the selected audio by the audio data selector and the text inputted form the user input text receiver.

In a further another aspect of the present invention, there is provided a multimedia chatting system, including: a selector for selecting an image and/or audio; a user input text receiver for receiving text from a user; and a communication processing unit for transmitting the selected image and/or audio by the selector, wherein the image includes a real-time image inputted by a camera and a pre-stored image, and the audio includes a real-time audio inputted by a microphone and a pre-stored audio.

In a still further another aspect of the present invention, there is provided a method for driving a multimedia chatting system, including: selecting image and/or audio for multimedia chatting; and transmitting the selected image and/or audio to an opponent.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a diagram illustrating a H.324 multimedia videophone system in accordance with the related art;

FIG. 2 is a block diagram illustrating a multimedia chatting system based on H.324 which is videophone standards of 3GPP in accordance with a preferred embodiment of the present invention;

FIG. 3 shows a user interface provided by a mobile phone in accordance with a preferred embodiment of the present invention; and

FIG. 4 is a diagram illustrating lower menus of a menu button in accordance with a preferred embodiment of the present invention.

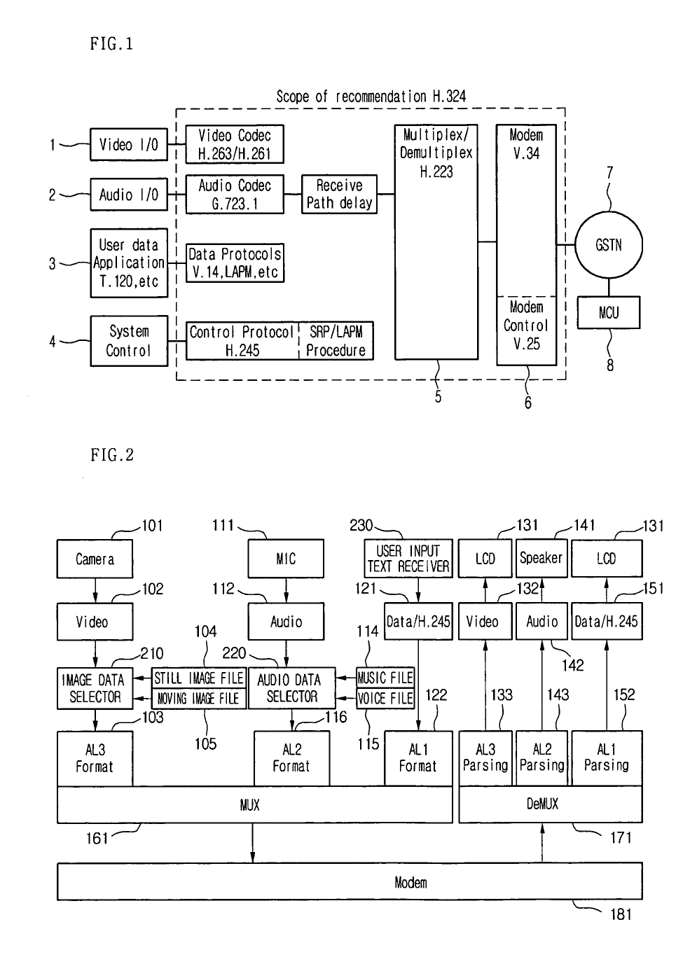

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

FIG. 2 is a block diagram illustrating a multimedia chatting system based on H.324 which is videophone standards of 3GPP in accordance with a preferred embodiment of the present invention.

The multimedia chatting system of the present invention includes an image data selector 210 for selecting an image, an audio data selector 220 for selecting audio and a user input text receiver 230 for receiving texts from the user within the relates art of a H.324 terminal. The multimedia chatting system of the present invention is compatible with the H.324 videophone protocol of 3GPP.

Hereinafter, a configuration of a mobile phone system in accordance with a present invention is explained.

For processing an image in the mobile phone of the present invention, the mobile phone includes a camera 101, real-time image data 102 which is photographed by the camera 101 and compressed, a still image file 104 and a moving image file 105. A user selects a predetermined image among the real-time image data 102, the still image file 104 and the moving image file 105 by using the image data selector 210.

The selected data by the image data selector 210 is transmitted to a multiplexer 161 through an AL3 application layer 103. As mentioned above, the selected image data may be one of the image data 102 which is took by the camera 101 and compressed, the still image file 104 and the moving image file 105 stored in the mobile phone. Therefore, the user may selects one of the still image file 104 and the moving image file 105 to transmit to a target terminal although the mobile phone does not include the camera 101.

Also, the mobile phone of the present invention includes a microphone 111, a sound data 102 which is inputted through the microphone 111, and a music file 114 and a voice file 115 which are stored in the mobile phone. The user selects one of the sound data 102, the music file 114 and the voice file 115 by using the audio data selector 220.

The selected audio data by the audio data selector 220 is transmitted to the multiplexer 161 through an AL2 application layer 116. As mentioned above, an output data from the audio data selector 220 may be one of the sound data 102, the music file 114 and the voice file 115.

For processing a text in the mobile phone of the present invention, the mobile phone includes the user input text receiver 230. The user input text receiver 230 receives text inputted by the user through a terminal interface. The user input text receiver 230 is controlled by a data/H.245 protocol 121 and the received text is transmitted to the multiplexer 161 through an AL1 application layer 122.

As mentioned above, the multimedia chatting system of the mobile phone in accordance with the present invention can transmit a user wanted image or audio based on the H.324 protocol by using the image data selector 210 for selecting one of the real-time image inputted from the camera, the stored still image and the stored moving image files, the data selector 220 for selecting one of the real-time sound inputted from the microphone, the stored music and the stored voice files, and the user input text receiver 230.

The multiplexer 161 transmits data to external device through a MODEM 181.

Furthermore, the mobile phone further includes a receiver for processing data received from the external device. The receiver includes a MODEM 181 for communication with the external device. The data received through the MODEM 181 is de-multiplexed by the de-multiplexer 161 and the de-multiplexed data is passed through AL3 parsing 133, AL2 parsing 143, AL1 parsing 152. After then, image data 132 is displayed at a LCD 131, audio data 142 is outputted to a speaker 141 and text is controlled based on data/H.245 protocol 151 and displayed at the LCD 131.

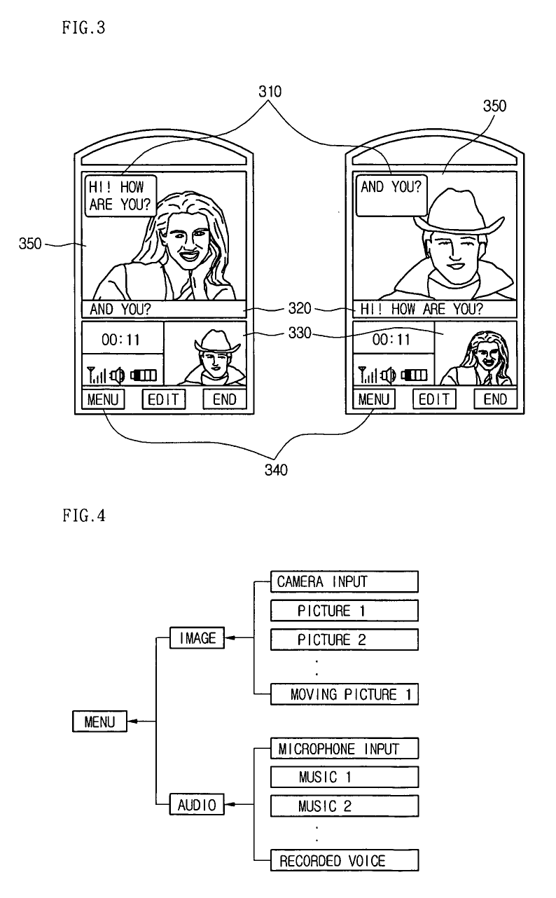

FIG. 3 shows a user interface provided by a mobile phone in accordance with a preferred embodiment of the present invention.

By referring to FIG. 3, the user interface of the present invention includes a user selection image display window 330 for displaying an image selected by the user, a menu button 340 for selecting a predetermined image data or a predetermined audio data during multimedia chatting, a chatting message display window 310 for receiving message to be transmitted from the user, a received image display window 350 for displaying a received image and a user text input window 320 for displaying message to be transmitted.

Also, the menu button 340 may includes lower menus as shown in FIG. 4. By referring FIG. 4, the lower menus of the menu button 340 may include an image and an audio. And, lower menus of the image menu may include menus for a camera input image, a still image or a moving image in order to select one of them. Moreover, the lower menus of the audio menu may include menus for selecting one a mic input sound, a music file or a voice file.

By referring FIGS. 3 and 4, operations of the multimedia chatting system in accordance with a preferred embodiment of the present invention are explained in detail. At first, the operations of the multimedia chatting system based on videophone protocol H.324 is activated by establishing a call connection between two terminals. After establishing the call connection, both of the terminals transmit/receive video, audio and text data to each others. In case of the mobile phone having no built-in camera, the still image or the moving image stored in the mobile phone is used because the mobile phone cannot receive the real-time image from the built-in camera.

After transmitting/receiving the video, the audio or the text data between the two terminals, the user may change media data during communication. In case that a user wants other image data during using a real-time image for multimedia chatting, the user transmits the one of the still image and the moving image file by selecting one of the still image and the moving image file stored in the mobile phone.

The still image file and the moving image file are compressed and stored in the mobile phone. Before transmitting the compressed still image file and the compressed moving image file, the mobile phone transmits a H.245 conference message for informing a compressed format of the transmitted data. Therefore, the receiving mobile phone can determines the compress format of the received still image or the received moving image file based on the H.245 conference message for decompressing the received still image or the received moving image file. By using the above mentioned method, the user can select image data to be transmitted any time during multimedia chatting.

In case of the audio data, the user selects one of the music file or the voice file stored in the mobile phone by using the audio data selector during performing multimedia chatting with the real-time sound data and the selected one of the music file or the voice file is transmitted to other mobile phone. Before, transmitting the selected file, the mobile phone transmits H.245 conference message for noticing a data format of the transmitted audio file. Accordingly, the receiving mobile phone properly recovers the received audio data based on the data format by using the H.245 conference message. Furthermore, a user can input a text string anytime during multimedia chatting.

The user may perform the multimedia chatting by using various multimedia combinations by using the menu button 340 in FIG. 3 anytime during multimedia chatting. For example, if a user wants silent chatting by using only an image and a text, it can be achieved by setting a menu of the audio as a silent. Also, by using the menu button 340, the chatting is performed with the music file instead of using the real-time sound data. That is, the multimedia chatting is performed with various combinations of the still image, the music file and the text by using the menu button 340.

The multimedia chatting system using various media data such as image, audio and text based on the videophone protocol H.324 of 3GPP in mobile communication environment is disclosed. Accordingly, the user can use not only videophone but also various multimedia chatting services by using simple structure of the present invention without modifying the related art videophone protocol H.324 in 3GPP network. Also, the user can use the multimedia chatting service by using a mobile phone having no built-in camera based on the videophone protocol because the multimedia chatting system of the present invention is compatible with the related art of H.324.

In accordance with the related art, both of the mobile phones must equip a built-in camera for the videophone communication. However, in the multimedia chatting system of the present invention, the videophone communication can be established between a mobile phone having the built-in camera and the mobile phone without the built-in camera. That is, the mobile phone with the built-in camera transmits the real-time image inputted by the built-in camera and the mobile phone without the built-in camera transmits images stored in the mobile phone for videophone communication in accordance with a present invention.

Moreover, the multimedia chatting system of the present invention can be used in a place where the audio communication is not proper such as a movie theater or a meeting by communicating each other with using only image and text.

Furthermore, the multimedia chatting system can communicate with other mobile phone by using various combinations of image, audio and text. The various combinations of image, audio and text are transmitted by using H.245 conference message, which is a control protocol of H.324 for transferring information of media type and media codec type. Therefore, the user can use the various types of multimedia chatting by using any media whenever or wherever user wants.

Furthermore, in accordance with the present invention, the multimedia chatting can be embodied without using additional multimedia server in a mobile phone based on H.324 which is a videophone protocol standardized by 3^{rd} Generation Partnership Project (3GPP).

It will be apparent to those skilled in the art that various modifications and variations can be made in the present invention. Thus, it is intended that the present invention covers the modifications and variations of this invention provided they come within the scope of the appended claims and their equivalents.

1. A mobile phone, comprising:
an image data selector for selecting a type of an image to be transmitted:
an audio data selector for selecting a type of audio to be transmitted;
a user input text receiver for receiving a text from a user;
a communication processing unit for transmitting the selected image by the image data selector, the selected audio by the audio data selector and the inputted text by the user input receiver;
a menu button for changing image data and/or audio data; and
a receiver for processing data received from an external device by the communication processing unit.

2. The mobile phone according to claim 1, wherein the communication processing unit is driven by H.324 protocol.

3. The mobile phone according to claim 1, wherein the selected image by the image data selector is one of a real-time image inputted by a built-in camera of the mobile phone, a still image stored in the mobile phone and a moving image stored in the mobile phone.

4. The mobile phone according to claim 1, the selected audio by the audio data selector is one of a real-time audio inputted by a microphone, a music file stored in the mobile phone and a voice file stored in the mobile phone.

5. The mobile phone according to claim 1, wherein menus selected by the menu button include a silent function.

6. The mobile phone according to claim 1, wherein the menu button individually selects image and audio.

7. The mobile phone according to claim 1, wherein image, audio and text are processed and displayed in the receiver.

8. The mobile phone of claim 1, wherein the image and the audio are changed during communication by using the menu button.

9. A multimedia chatting system, comprising:
an image data selector for selecting an image to be transmitted;
an audio data selector for selecting audio to be transmitted;
a user input text receiver for receiving a text; and
a communication processing unit for transmitting the selected image by the image data selector, the selected audio by the audio data selector and the text inputted form the user input text receiver.

10. The multimedia chatting system according to claim 9, wherein the image includes a pre-stored still image and a pre-stored moving image.

11. The multimedia chatting system according to claim 9, wherein the image includes a real-time image inputted from a camera.

12. The multimedia chatting system according to claim 9, wherein the audio includes a music and/or a voice.

13. The multimedia chatting system according to claim 9, wherein the audio includes a real-time audio inputted by a microphone.

14. The multimedia chatting system according to claim 9, wherein the audio data selector selects no audio to be transmitted.

15. The multimedia chatting system according to claim 9, wherein the communication processing unit is driven based on H.324 protocol.

16. A multimedia chatting system, comprising:
a selector for selecting an image and/or audio;
a user input text receiver for receiving text from a user; and
a communication processing unit for transmitting the selected image and/or audio by the selector,
wherein the image includes a real-time image inputted by a camera and a pre-stored image, and the audio includes a real-time audio inputted by a microphone and a pre-stored audio.

17. A method for driving a multimedia chatting system, comprising:
selecting image and/or audio for multimedia chatting; and
transmitting the selected image and/or audio to an opponent.

18. The method according to claim 17, wherein the image includes a real-time image inputted by a camera, a pre-stored still image file and a pre-stored moving image file.

19. The method according to claim 17, wherein the audio includes a real-time audio inputted by a microphone, a pre-stored music file and a pre-stored voice file.

20. The method according to claim 17, wherein a conference message is transmitted to the opponent for informing a format of transmitted data based on H.245 protocol before transmitting the selected image and audio.

21. The method according to claim 17, wherein the selected image, the selected audio and text inputted by a user are transmitted based on H.324 protocol.
